(19) United States
(12) Patent Application Publication
(10) Pub. No.: US 2024/0269816 A1
(43) Pub. Date: Aug. 15, 2024

(54) Dual-Sided Wrench Device

(71) Applicant: Jason Hornback, Denver City, TX (US)

(72) Inventor: Jason Hornback, Denver City, TX (US)

(21) Appl. No.: 18/366,362

(22) Filed: Aug. 7, 2023

Related U.S. Application Data
(60) Provisional application No. 63/444,370, filed on Feb. 9, 2023.

(51) Int. Cl. B25F 1/00; B25B 13/50

(52) U.S. Cl. CPC B25F 1/003; B25B 13/5058

(57) ABSTRACT

A dual-sided wrench device is provided. The device is primarily comprised of a first wrench and a second wrench connected by a handle, and wherein each is preferably made of a metal material capable of withstanding large amounts of force and torque. The first wrench may be adjusted to fit around various fasteners such that they can be easily tightened or loosened. The second wrench may be adjusted to clamp and grip onto various pipe sizes such that they can easily be twisted, tightened, or loosened.

### CROSS-REFERENCE TO RELATED APPLICATION

The present application claims priority to, and the benefit of, U.S. Provisional Application No. 63/444,370, which was filed on Feb. 9, 2023, and is incorporated herein by reference in its entirety.

### FIELD OF THE INVENTION

The present invention relates generally to the field of wrenches. More specifically, the present invention relates to a dual-sided wrench device. The device is primarily comprised of a first wrench and a second wrench connected by a handle, wherein the first wrench and second wrench are different wrench types. Accordingly, the present disclosure makes specific reference thereto. Nonetheless, it is to be appreciated that aspects of the present invention are also equally applicable to other like applications, devices, and methods of manufacture.

### BACKGROUND

Many different tools may be used to accomplish a specific task, the multiple tasks, when building, repairing, installing, etc. However, constantly searching for tools to accomplish a specific task can waste the time of the user as well as lead to frustration when said tool cannot be found easily. Further, if an individual has to perform work on a ladder, switching tools may involve repeatedly climbing up and down the ladder to find the specific tool, which is time-consuming.

Therefore, there exists a long-felt need in the art for a device that embodies the function of two separate handheld tools into one. More specifically, there exists a long-felt need in the art for a dual-sided wrench device that provides two different types of wrenches in one device. Furthermore, there exists a long-felt need in the art for a dual-sided wrench device that can be easily attached to a user, such that the device is within reach when working on a worksite.

The subject matter disclosed and claimed herein, in one embodiment thereof, comprises a dual-sided wrench device. The device is comprised of a first wrench and a second wrench connected by a central handle. In the preferred embodiment, the first wrench is comprised of an adjustable crescent wrench that may be adjusted to fit around various fasteners for tightening/loosening. The second wrench may be comprised of an adjustable pipe wrench that may be used on various pipe sizes for tightening and loosening. In addition, the handle of the device may be comprised of an opening to allow the device to be attached to a user's person via a clip, rope, etc.

In this manner, the dual-sided wrench device of the present invention accomplishes all the foregoing objectives and provides a device that embodies the function of two separate handheld tools into one. More specifically, the dual-sided wrench device can be applied to pipes, nuts, or other similar objects to be tightened, loosened, or twisted. Furthermore, the dual-sided wrench device can be easily attached to a tool bag, belt loop, or other accessory of a worker to maintain ease of access to the device while working.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dual-sided wrench device comprised of a first wrench, a handle, and a second wrench. The device is designed to combine the function of two separate wrench tools into a singular device, thereby reducing the amount of time searching for tools in a toolbox or swapping out one tool for another.

The device is comprised of a first end and a second end. The first end is comprised of an adjustable crescent wrench which is comprised of a worm screw, a fixed jaw, an adjustable jaw, and a seat. The fixed jaw remains stationary such that when the worm screw is twisted, the adjustable jaw moves along the length of the seat closer to, or further from, the fixed jaw. The adjustable jaw and the fixed jaw may then be fitted around a fastener or other hardware to be twisted, tightened, or loosened.

The first end and the second end are connected via a handle. The handle acts as a gripping point for a user and may be attached to an accessory of the user (such as a clip, carabiner, rope, etc.) via an at least one opening. The second end is comprised of a second wrench, which is preferably an adjustable pipe wrench comprised of a hook jaw, a heel jaw, and an adjustment nut. The heel jaw remains stationary and, when the adjustment nut is twisted, the hook jaw extends away from or moves closer to the heel jaw, depending on the direction of the rotation of the adjustment nut. The hook jaw and heel jaw may then be fitted around a pipe or other hardware to be twisted, tightened, or loosened.

The present invention is also comprised of a first method of using the device. First, a device is provided comprised of a first wrench, a handle, and a second wrench. Then, a worm screw of the first wrench may be twisted to move an adjustable jaw of the first wrench to a desired distance away from the fixed jaw. Then, the first wrench may be applied to a fastener or other hardware to be tightened or loosened. Next, the first wrench may be removed from the fastener and the device may be rotated to use the second wrench. Then, the adjustment nut of the second wrench may be twisted, moving the hook jaw to a desired distance away from the heel jaw. Then, the second wrench may be applied to a pipe or other hardware to be twisted, tightened, or loosened.

The present invention is also comprised of a second method of using the device. First, a device is provided comprised of a first wrench, a handle, and a second wrench. Then, the adjustment nut of the second wrench may be twisted to move the hook jaw to a desired distance away from the heel jaw. Then, the second wrench may be applied to a pipe or other hardware to be twisted, tightened, or loosened. Next, the second wrench may be removed from the fastener and the device may be flipped around. Then, the worm screw of the first wrench may be twisted, moving the adjustable jaw to a desired distance away from the fixed jaw. Then, the first wrench may be applied to a fastener or other hardware to be tightened or loosened.

Accordingly, the dual-sided wrench device of the present invention is particularly advantageous as it provides a device that embodies the function of two separate handheld tools into one. More specifically, the dual-sided wrench device can be easily attached to a tool bag, belt loop, or other accessory of a worker to maintain ease of access while working on a worksite. Furthermore, the dual-sided wrench device can be applied to a variety of different fasteners, pipes, or other similar objects to be tightened, loosened, or twisted into place. In this manner, the dual-sided wrench device overcomes the limitations of existing handheld tools known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a dual-sided wrench device of the present invention in accordance with the disclosed architecture;

FIG. 2 illustrates an enhanced perspective view of one potential embodiment of a dual-sided wrench device of the present invention in accordance with the disclosed architecture;

FIG. 3 illustrates an enhanced perspective view of one potential embodiment of a dual-sided wrench device of the present invention in accordance with the disclosed architecture;

FIG. 4 illustrates a flowchart of a method of using one potential embodiment of a dual-sided wrench device of the present invention in accordance with the disclosed architecture; and

FIG. 5 illustrates a flowchart of a second method of using one potential embodiment of a dual-sided wrench device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that embodies the function of two separate handheld tools into one. More specifically, there exists a long-felt need in the art for a dual-sided wrench device that provides two different types of wrenches in one device. Furthermore, there exists a long-felt need in the art for a dual-sided wrench device that can be easily attached to a user, such that the device is within reach when working on a worksite.

The present invention, in one exemplary embodiment, is comprised of a dual-sided wrench device. The device is comprised of a first wrench, a handle, and a second wrench. The device is designed to combine the function of two separate wrench tools into a singular device, thereby reducing the amount of time searching for tools in a toolbox or swapping out one tool for another.

More specifically, the device is comprised of a first end and a second end, each preferably made from a metal material. The first end is comprised of a first wrench, which is preferably an adjustable crescent wrench. The first wrench is preferably comprised of a worm screw, a fixed jaw, an adjustable jaw, and a seat. The worm screw may be accessible from the surface of the first wrench such that by scrolling or twisting the worm screw, the adjustable jaw may move. The fixed jaw may remain stationary as it is fixedly attached to the seat of the first wrench. As the worm screw is twisted, the adjustable jaw may move along the length of the seat, shrinking or widening the gap between the fixed jaw and the adjustable jaw.

The first end is then connected to the second end via a handle. The handle may be comprised of a grip to provide a user with a secure contact point and an opening in which a clip or other attachment object may be placed through to secure the device to another object. The second end is comprised of a second wrench, which is preferably an adjustable pipe wrench. The adjustable pipe wrench is preferably comprised of a hook jaw, a heel jaw, and an adjustment nut. The hook jaw may move by twisting the adjustment nut. The heel jaw may remain stationary as it is fixedly attached to the second end. As the adjustment nut is twisted, the hook jaw may extend further from, or move closer to, the heel jaw to accommodate objects of differing size in which the device may be used upon.

The present invention is also comprised of a first method of using the device. First, a device is provided comprised of a first wrench, a handle, and a second wrench. Then, the worm screw of the first wrench may be twisted, moving the adjustable jaw to a desired distance away from the fixed jaw. Then, the first wrench may be applied to a fastener or other hardware to be tightened or loosened. Next, the first wrench may be removed from the fastener and the device may be flipped around. Then, the adjustment nut of the second wrench may be twisted, moving the hook jaw to a desired distance away from the heel jaw. Then, the second wrench may be applied to a pipe or other hardware to be twisted, tightened, or loosened.

The present invention is also comprised of a second method of using the device. First, a device is provided comprised of a first wrench, a handle, and a second wrench. Then, the adjustment nut of the second wrench may be twisted, moving the hook jaw to a desired distance away from the heel jaw. Then, the second wrench may be applied to a pipe or other hardware to be twisted, tightened, or loosened. Next, the second wrench may be removed from the fastener and the device may be flipped around. Then, the worm screw of the first wrench may be twisted, moving the adjustable jaw to a desired distance away from the fixed jaw. Then, the first wrench may be applied to a fastener or other hardware to be tightened or loosened.

Accordingly, the dual-sided wrench device of the present invention is particularly advantageous as it provides a device that embodies the function of two separate handheld tools into one. More specifically, the dual-sided wrench device can be applied to a variety of different fasteners, pipes, or other similar objects and can easily rotate them to be tightened, loosened, or twisted into place. Furthermore, the dual-sided wrench device can be easily attached to an accessory of a worker, such that the device is easily accessible while working on a worksite. In this manner, the dual-sided wrench device overcomes the limitations of existing handheld tools known in the art.

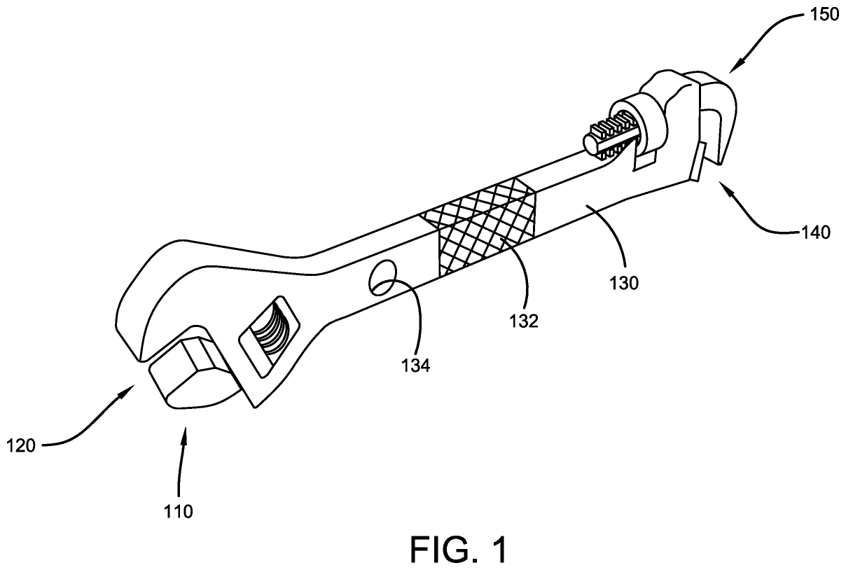

Referring initially to the drawings, FIG. 1 illustrates a perspective view of one potential embodiment of a dual-sided wrench device 100 of the present invention in accordance with the disclosed architecture. The device 100 is comprised of a first wrench 120, a handle 130, and a second wrench 150. The device 100 is designed to combine the function of two separate wrench tools into a singular device 100, thereby reducing the amount of time searching for tools in a toolbox or swapping out one tool for another.

The device 100 is comprised of a first end 110 and a second end 140 that are preferably made of a metal material capable of withstanding large amounts of torque and force. The first end 110 and the second end 140 of the device 100 are fixedly attached to either end of a handle 130. The handle 130 may be comprised of a grip 132 and an at least one opening 134. The grip 132 of the handle 130 may be comprised of a differing material from the device 100, such as a non-slip material such as, but not limited to, rubber. The handle 130 may be textured with a raised or recessed texture to aid a user in gripping and using the device 100. The opening 134 of the handle 130 may be used to attach the device 100 to an accessory of a worker. In one potential embodiment, a clip, rope, carabiner, etc., may be used to fasten the device 100 to a belt loop or tool bag by inserting through the opening 134 of the handle 130 and closing around a belt loop or tool bag.

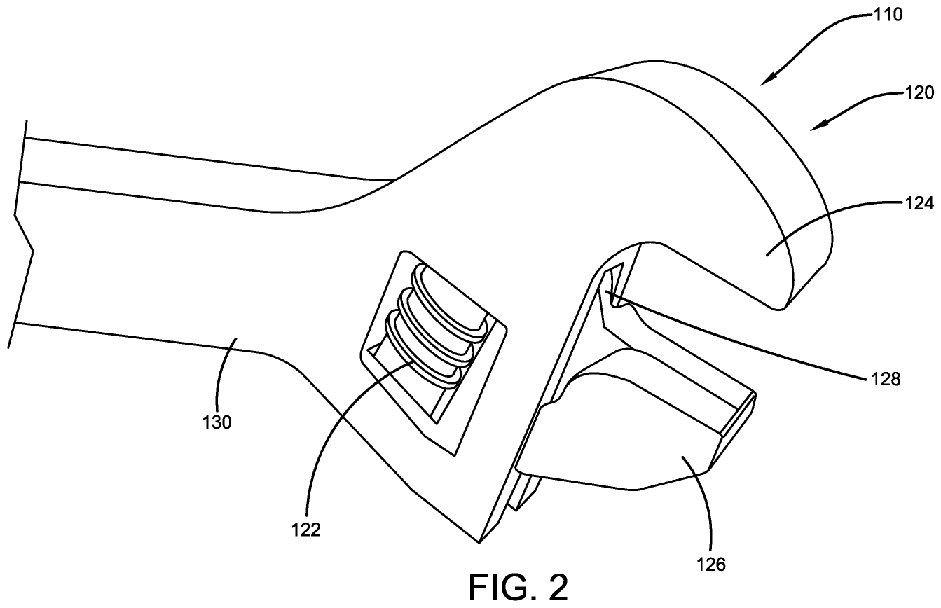

FIG. 2 illustrates an enhanced perspective view of one potential embodiment of a dual-sided wrench device 100 of the present invention in accordance with the disclosed architecture. The first end 110 of the device 100 is comprised of a first wrench 120. The first wrench 120 is preferably (but not limited to) an adjustable crescent wrench comprised of a worm screw 122, a fixed jaw 124, an adjustable jaw 126, and a seat 128. The worm screw 122 may be accessible from either side of the first wrench 120, such that when the worm screw 122 is twisted, the adjustable jaw 126 moves closer to or further away from the fixed jaw 124, depending on the clockwise or counterclockwise rotation of the worm screw 122. The fixed jaw 124 remains stationary and is fixedly attached to the seat 128 of the first wrench 120. When the worm screw 122 is twisted, the adjustable jaw 126 moves along the length of the seat 128. Once the adjustable jaw 126 is at a desired distance from the fixed jaw 124, the first wrench 120 may be fitted around a fastener or other mechanical hardware to be tightened or loosened.

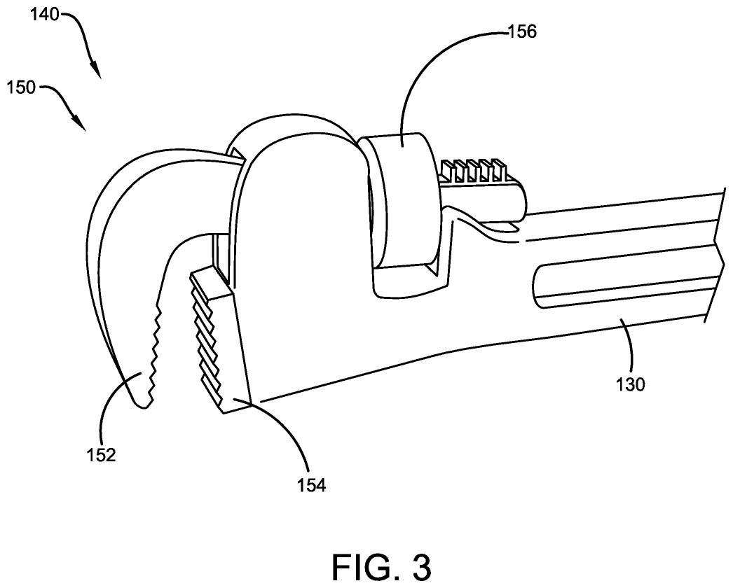

FIG. 3 illustrates an enhanced perspective view of one potential embodiment of a dual-sided wrench device 100 of the present invention in accordance with the disclosed architecture. The second end 140 of the device 100 is further comprised of a second wrench 150 such as, but not limited to, an adjustable pipe wrench. The second wrench 150 is comprised of a hook jaw 152, a heel jaw 154, and an adjustment nut 156. The hook jaw 152 may move along the axis of the handle 130 by the twisting motion of the adjustment nut. The hook jaw 152 may move closer to or further away from the heel jaw 154, which remains stationary and is fixedly attached to the second end 140 of the device 100. Depending on the clockwise or counterclockwise rotation of the adjustment nut 156, the hook jaw 152 may extend further from or move closer to the heel jaw 154. In one potential embodiment, both the hook jaw 152 and the heel jaw 154 may be made of serrated surfaces to provide additional grip to the surface on which the second wrench 150 may be applied. Once the hook jaw 152 is at a desired distance from the heel jaw 154, the second wrench 150 may be fitted around a pipe or other hardware to be twisted.

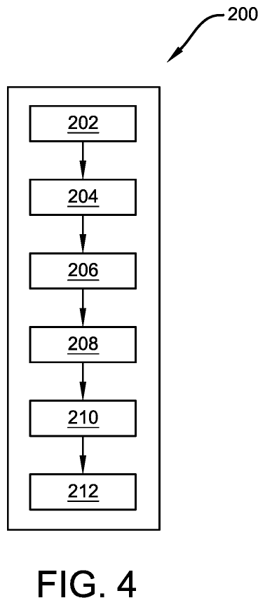

The present invention is also comprised of a first method 200 of using the device 100, as seen in FIG. 4. First, a device 100 is provided comprised of a first wrench 120, a handle 130, and a second wrench 150 [Step 202]. Then, a worm screw 122 of the first wrench 120 may be twisted, moving the adjustable jaw 126 to a desired distance away from the fixed jaw 124 [Step 204]. Then, the first wrench 120 may be applied to a fastener (or other hardware) to be tightened or loosened [Step 206]. Next, the first wrench 120 may be removed from the fastener and the device 100 may be rotated 180 degrees [Step 208]. Then, the adjustment nut 156 of the second wrench 150 may be twisted, moving the hook jaw 152 to a desired distance away from the heel jaw 154 [Step 210]. Then, the second wrench 150 may be applied to a pipe or other hardware to be twisted, tightened, or loosened [Step 212].

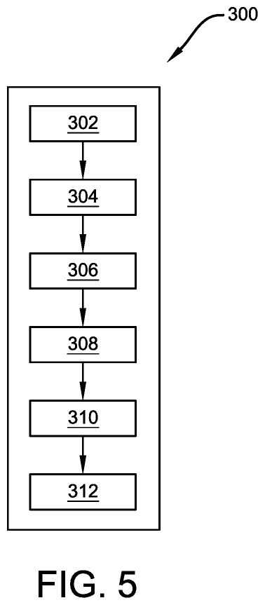

The present invention is also comprised of a second method 300 of using the device 100, as seen in FIG. 5. First, a device 100 is provided comprised of a first wrench 120, a handle 130, and a second wrench 150 [Step 302]. Then, the adjustment nut 156 of the second wrench 150 may be twisted, moving the hook jaw 152 to a desired distance away from the heel jaw 154 [Step 304]. Then, the second wrench 150 may be applied to a pipe or other hardware to be twisted, tightened, or loosened [Step 306]. Next, the second wrench 150 may be removed from the fastener and the device 100 may be rotated 180 degrees [Step 308]. Then, a worm screw 122 of the first wrench 120 may be twisted, moving the adjustable jaw 126 to a desired distance away from the fixed jaw 124 [Step 310]. Then, the first wrench 120 may be applied to a fastener or other hardware to be tightened or loosened [Step 312].

It should be appreciated that the wrenches 120, 150 may be any type of wrenches known in the art. Said wrench types include, but are not limited to, fixed or adjustable wrenches such as crescent wrenches, dog bone wrenches, crowfoot wrenches, lug wrenches, basin wrenches, oil filter wrenches, fan clutch wrenches, plumber's wrenches, pedal wrenches, striking wrenches, chain wrenches, socket wrenches, torque wrenches, armorer's wrenches, tap wrenches, spud wrenches, strap wrenches, alligator wrenches, fan clutch wrenches, torx wrenches, box-ended wrenches, cone wrenches, pliers wrenches, Allen wrenches, Saltus wrenches, pipe wrenches, ratcheting wrenches, etc.

In one embodiment, the wrenches 120, 150 may be non-adjustable wrenches of the same type, but of differing sizes, patterns, configurations, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dual-sided wrench device” and “device” are interchangeable and refer to the dual-sided wrench device 100 of the present invention.

Notwithstanding the foregoing, the dual-sided wrench device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the dual-sided wrench device 100 as shown in the FIGS. are for illustrative purposes only, and that many other sizes and shapes of the dual-sided wrench device 100 are well within the scope of the present disclosure. Although the dimensions of the dual-sided wrench device 100 are important design parameters for user convenience, the dual-sided wrench device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dual-sided wrench device comprising:
a first end comprised of a first wrench;
a second end comprised of a second wrench; and
a handle connected to the first end and the second end.

2. The dual-sided wrench device of claim 1, wherein the handle is comprised of an opening.

3. The dual-sided wrench device of claim 1, wherein the handle is comprised of a grip area.

4. The dual-sided wrench device of claim 3, wherein the grip area is comprised of a non-slip material.

5. The dual-sided wrench device of claim 4, wherein the non-slip material is comprised of a raised texture or a recessed texture.

6. The dual-sided wrench device of claim 1, wherein the type of wrench of the first wrench differs from the type of wrench of the second wrench.

7. A dual-sided wrench device comprising:
a first end comprised of an adjustable crescent wrench;
a second end comprised of an adjustable pipe wrench; and
a handle connected to the first end and the second end, the handle comprised of an opening.

8. The dual-sided wrench device of claim 7, wherein the adjustable crescent wrench is comprised of a worm screw.

9. The dual-sided wrench device of claim 7, wherein the adjustable crescent wrench is comprised of a fixed jaw.

10. The dual-sided wrench device of claim 7, wherein the adjustable crescent wrench is comprised of an adjustable jaw.

11. The dual-sided wrench device of claim 7, wherein the adjustable crescent wrench is comprised of a seat.

12. The dual-sided wrench device of claim 7, wherein the adjustable pipe wrench is comprised of a hook jaw.

13. The dual-sided wrench device of claim 12, wherein the hook jaw is comprised of a serrated surface.

14. The dual-sided wrench device of claim 7, wherein the adjustable pipe wrench is comprised of a heel jaw.

15. The dual-sided wrench device of claim 14, wherein the heel jaw is comprised of a serrated surface.

16. The dual-sided wrench device of claim 7, wherein the adjustable pipe wrench is comprised of an adjustment nut.

17. A method of using a dual-sided wrench device, the method comprising the following steps:
providing a dual-sided wrench device comprised of a first wrench, a handle, and a second wrench;
moving a first jaw of the first wrench;
applying and tightening the first wrench around a first fastener;
removing the first wrench from the fastener and rotating the first wrench 180 degrees;
moving a second jaw of the second wrench; and
applying and tightening the second wrench around a second fastener.

18. The method of claim 17, wherein the first wrench is comprised of an adjustable crescent wrench.

19. The method of claim 17, wherein the second wrench is comprised of an adjustable crescent wrench.

20. The method of claim 17, wherein the handle connects the first wrench to the second wrench.
